(19) United States
(12) Patent Application Publication
(10) Pub. No.: US 2010/0126883 A1
(43) Pub. Date: May 27, 2010

(54) SENSOR ELEMENT HAVING SUPPRESSED RICH GAS REACTION

(76) Inventors: Henrico Runge, Stuttgart (DE); Holger Reinshagen, Bamberg (DE); Lothar Diehl, Gerlingen (DE); Thomas Seiler, Stuttgart (DE)

Correspondence Address: KENYON & KENYON LLP, ONE BROADWAY, NEW YORK, NY, 10004, US

(21) Appl. No.: 12/521,686

(22) PCT Filed: Nov. 16, 2007
(86) PCT No.: PCT/EP07/62460

§ 371 Date: Feb. 2, 2010

(30) Foreign Application Priority Data
Dec. 29, 2006 (DE) 10 2006 062 056.9

(51) Int. Cl. G01N 27/407; G01N 27/26; F01N 11/00; F02B 77/08

(52) U.S. Cl. 205/784.5; 204/427; 204/428

(57) ABSTRACT

A sensor element for determining at least one physical property of a gas mixture is provided. The sensor element has at least one first electrode and at least one second electrode, and at least one solid electrolyte that connects the at least two electrodes. The at least one first electrode is connected via at least one diffusion-resistance element to the at least one gas chamber and/or to at least one reference chamber. The at least one second electrode is connected via at least one flow-resistance element to the at least one gas chamber. The at least one flow-resistance element and the at least one diffusion-resistance element are designed in such a way that the limit current of the at least one first electrode is smaller than the limit current of the at least one second electrode.

### FIELD OF THE INVENTION

The present invention relates to sensor elements which are based on the electrolytic properties of specific solids, thus on the ability of these solids to conduct specific ions.

### BACKGROUND INFORMATION

Sensor elements of this kind are used, for example, in motor vehicles to measure air-fuel gas mixture compositions. Such sensor elements are also known by the designation “lambda oxygen sensor” and play an important role in reducing pollutants in exhaust emissions, both in Otto engines as well as in the context of Diesel-engine technology.

In combustion engineering, what is commonly referred to as the “lambda” value (λ) generally denotes the ratio between an actually provided air mass and an air mass (i.e., stoichiometric air mass) that is theoretically required for combustion. The lambda value is measured by one or a plurality of sensor elements, and in most cases at one or a plurality of locations in the exhaust tract of an internal combustion engine. Accordingly, “rich” gas mixtures (i.e., gas mixtures having excess fuel) have a lambda value of λ<1, whereas “lean” gas mixtures (i.e., gas mixtures having a fuel deficiency) have a lambda value of λ>1. Sensor elements of this type and those similar thereto are not only used in motor-vehicle technology, but in other engineering sectors as well (particularly in combustion engineering), for example, in aeronautics or in the control of burners, for example, in heating systems or power plants.

These types of sensor elements have become known in a variety of numerous specific embodiments. One specific embodiment is what is generally referred to as a “step-change sensor,” whose measuring principle is based on the measurement of an electrochemical potential difference between a reference electrode exposed to a reference gas and a measuring electrode exposed to the gas mixture to be measured. The reference electrode and the measuring electrode are interconnected by the solid electrolyte; due to its oxygen ion-conducting properties, doped zirconium dioxide (for example, yttrium-stabilized ZrO₂) or similar ceramics being used as solid electrolyte. At the very transition between the rich gas mixture and the lean gas mixture, the potential difference between the electrodes theoretically exhibits a characteristic step change which can be utilized to actively control the gas mixture composition to around the transition point λ=1. Various exemplary embodiments of these types of step-change sensors, which are also referred to as “Nerst cells,” are described, for example, in the German Patent Application Nos. DE 10 2004 035 826 A1, DE 199 38 416 A1 and DE 10 2005 027 225 A1.

Alternatively or in addition to step-change sensors, what are generally referred to as “pump cells” are also used in situations where an electrical “pump voltage” is applied to two electrodes that are connected by the solid electrolyte, the “pump current” across the pump cell being measured. In contrast to the step-change sensor principle, pump cells typically involve both electrodes communicating with the gas mixture to be measured. One of the two electrodes is directly exposed (mostly via a permeable protective layer) to the gas mixture to be measured. However, the second of the two electrodes is designed in such a way that the gas mixture is not able to directly reach this electrode, but must initially penetrate what is generally referred to as a “diffusion barrier” in order to arrive in a cavity adjoining this second electrode. For the most part, a porous ceramic structure having selectively adjustable pore radii is used as a diffusion barrier. If lean exhaust gas enters through this diffusion barrier into the cavity, oxygen molecules are electrochemically reduced to oxygen ions by the pump voltage at the second, negative electrode, are transported through the solid electrolyte to the first, positive electrode and re-released there as free oxygen. The sensor elements are mostly operated in what is generally referred to as limit current operation, i.e., in an operation in which the pump voltage is selected in such a way that the oxygen entering through the diffusion barrier is completely pumped to the counter-electrode. In this operation, the pump current is approximately proportional to the partial pressure of the oxygen in the exhaust gas mixture, so that sensor elements of this kind are often also described as proportional sensors. In contrast to step-change sensors, such proportional sensors are able to be used as what is generally referred to as wide-range lambda sensors over a comparatively wide lambda value range. Wide-range lambda sensors of this kind are described, for example, in the German Patent Publication DE 38 09 154 C1 and in the German Patent Application No. DE 199 38 416 A1.

In many sensor elements, the sensor principles described above are also sometimes combined, so that the sensor elements contain one or a plurality of sensors (“cells”) which function in accordance with the step-change sensor principle and one or a plurality of proportional sensors. Thus, the above described principle of a “single-cell sensor element” that functions in accordance with the pump cell principle is able to be broadened by adding a step-change cell (Nernst cell) to form a “double-cell sensor element.” A structure of this kind is described, for example, in Examined Patent Application EP 0 678 740 B1. In this case, a Nernst cell is used to measure the oxygen partial pressure in the above described cavity that is contiguous to the second electrode, and the pump voltage is adjusted by a feedback control in such a way that the condition λ=1 always prevails in the cavity.

However, various problems are associated with broadband sensor elements in a single-cell configuration having two electrodes exposed to the gas mixture. Thus, given a fixed pump voltage in a lean gas mixture, a positive pump current (lean pump current) having a unique relation to the oxygen content of the gas mixture, is typically measured. However, in the rich gas mixture, a positive pump current is likewise typically measured, even when the applied pump voltage (typically, approximately 600-700 mV) is considerably below the decomposition voltage of water (approximately 1.23 V). This positive pump current is essentially attributed to the molecular hydrogen contained in the gas mixture that influences the electrochemical potential of the anode, thus of the first electrode, since, at this point, instead of molecular oxygen, water may form at the first electrode from the oxygen ions emerging from the solid electrolyte. Similar effects also play a role for other oxygen-releasing redox systems present in the gas mixture, for example CO₂/CO. Thus, within the rich mixture range (rich pump current), the current is limited by the hydrogen concentration in the region of the first electrode (for example, anode) and by the water vapor concentration (i.e., in particular, the ingress of the water vapor through the diffusion barrier described above) in the region of the second electrode (for example, cathode). In this case, a difficulty arises that the rich pump current and the lean pump current exhibit the same electrical direction, so that it is no longer readily feasible to infer the composition of the gas mixture from the pump current. Besides the problems delineated here relating to the rich mixture range, a falsification of the pump current by the hydrogen is also noted in the slightly lean exhaust-gas range that is already present in this range and makes a positive contribution to the pump current.

### SUMMARY OF INVENTION

Embodiments of the present invention are based on the realization described above that the rich pump current and the pump current in the slightly lean exhaust-gas range are essentially determined by the hydrogen supply and/or other reducing gases in the region of the anode of a pump cell. An embodiment of the present invention involves shielding the anode from hydrogen and/or other reducing gases without thereby degrading the lean operation.

In an embodiment, a sensor element is provided for determining at least one physical property of a gas mixture in at least one gas chamber, which has at least one first electrode and at least one second electrode, as well as at least one solid electrolyte that connects the at least one first electrode and the at least one second electrode. This sensor element may be operated in such a way that the at least one first electrode is operated as an anode, and the at least one second electrode as a cathode. Between these at least two electrodes, a pump voltage is applied which may be between 100 mV and 1.0 V, or, for example, between 300 mV and 800 mV, and/or between 600 mV and 700 mV. In this context, a pump current may be measured by the sensor element.

The at least one first electrode is connected via at least one diffusion-resistance element to the at least one surrounding gas chamber (for example, a gas chamber surrounding the sensor element), in which the gas mixture composition is to be ascertained, and/or a reference chamber having a known gas chamber composition. The at least one second electrode is connected via at least one flow-resistance element to the at least one gas chamber. The at least one flow-resistance element and the at least one diffusion-resistance element are designed in such a way that the limit current of the at least one first electrode is smaller in magnitude than the limit current of the at least one second electrode. In this context, limit currents can be set for which there is a ratio of <1/100, in particular of <1/1000. The limit current of the at least one first electrode is, for example, 1 to 20 microamperes, especially 10 microamperes; and the limit current of the at least one second electrode is 500 microamperes to 3 milliamperes, especially 1.5 milliamperes. The limit current of an electrode is defined as the saturation pump current, i.e., the maximum pump current that is attainable given an increase in the pump voltage between the at least two electrodes. This limit current may be defined, for example, for oxygen and oxygen ion transport through the solid electrolyte, as that current which is reached when all oxygen molecules, which reach the electrode operated as a cathode, are completely transported through the solid electrolyte to the anode. This limit current, i.e., a sufficient pump voltage (see above), is typically used to operate the sensor element, so that the incoming gas molecules are completely “removed.” In this operation, the pump current is approximately proportional to the gas molecule concentration. Accordingly, the limit current of the opposite electrode, which had previously been operated as an anode, is experimentally determined by reversing the polarity, so that, at this point, the previous anode is operated as a cathode.

In an embodiment, the condition for the limit current ratio may be adjusted, in particular, in that the at least one diffusion-resistance element has a greater diffusion resistance than the at least one flow-resistance element. The diffusion resistance is that resistance by which an element opposes a concentration difference Δc between the two sides of the element of length 1 and which thus prevents a diffusion (current j):

$$j = - D \frac{Δ c}{1}$$

Diffusion coefficient D is composed (in an inversely additive manner) of the diffusion coefficients for the gas phase diffusion and for the Knudsen diffusion, which both exhibit different temperature dependencies. Thus, the temperature dependency of the flow is dependent on the proportions of the individual diffusion types. In response to a temperature variation of around 100° C., the flow changes by approximately 4%. Thus, to set a desired limit current, the geometry of the resistance elements (cross section, length) or also the material properties and the temperature may be influenced.

For this embodiment of the diffusion resistances, the same diffusion medium (for example, a porous material), for example, may be used for the at least one diffusion-resistance element and the at least one flow-resistance element, however, in different layer thicknesses, so that, for example, a greater layer thickness may be used in front of the at least one first electrode than in front of the at least one second electrode. Alternatively or additionally, the surface area of the resistance elements are also be adjusted. The limit current increases at least approximately proportionally to the cross-sectional area that is available for the diffusion, and inversely proportionally to the length, respectively layer thickness of the resistance elements.

In an embodiment, the at least one flow-resistance element exhibits a greater flow resistance than the at least one diffusion-resistance element. In this context, the flow resistance is defined as that resistance by which an element opposes a pressure difference between the two sides of the element and which thus prevents a flow between the two sides of the element. The flow resistance may be adjusted, for example, in that a pore size of a porous medium is increased, respectively reduced, and/or a channel cross section, a channel geometry or a channel length is varied.

The above described advantageous relationship between the limit currents brings about the above described shielding effect of the at least one first electrode against reducing gases, such as hydrogen, for example. For example, it is beneficial when this shielding is effected in that the at least one diffusion-resistance element has a diffusion channel which connects the at least one first electrode to the at least one gas chamber and/or to the at least one reference chamber. In an embodiment, the diffusion channel should be substantial in length, i.e., in comparison to the average free path length of the gas molecules at the corresponding operating temperature of the sensor element (for example, 700-800° C.). In this manner, the difference between the gas-phase diffusion and the flow resistance is able to be maximally utilized in order to effect a shielding of the at least one first electrode. If, for example, the gas molecules in the diffusion channel (self-evidently, a plurality of diffusion channels likewise being usable) did not have any other collision partners outside of the walls of the diffusion channel, then a transport would merely occur via a Knudsen diffusion at the same ratio for flow and diffusion. However, the embodiment as a diffusion channel results in an only low diffusion transport rate of rich gas toward the at least one first electrode (typically anode) and, thus, in only a small rich pump current. In an embodiment, the at least one diffusion channel is provided with a height within the range of between 2 L to 25 L, a width within the range of 2 L to 25 L, as well as a length within the range of between 0.5 mm and 20 mm. In this case, L is the average free path length of the molecules of the gas mixture at an operating pressure of the sensor element that is typically within the range of normal pressure. In an embodiment, such a dimensioning of the at least one diffusion channel has proven to be favorable with regard to preventing the diffusion of rich gas toward at least one first electrode.

For example, an embodiment according to the present invention of a sensor element in accordance with one of the above specific embodiments can be distinguished over the related art by extremely small rich pump currents. The pump current may be carried out, in the lean range as well, down to very small values for λ. The gradient of the “rich branch” is selectively reduced (when the pump current is plotted as a function of λ) by the at least one diffusion-resistance element which is in the region in front of the at least one first electrode and which shields the at least one first electrode against diffusion.

In an embodiment, at the same time, by embodying the at least one diffusion-resistance element to have a low flow resistance, the danger of an excess pressure in the region of the at least one first electrode (typically anode) due to the lack of gas removal is prevented since gas molecules which form at the at least one first electrode are able to be carried away directly. In an embodiment according to the present invention of the sensor element, a reference channel, which would have to be shielded from the gas chamber at considerable expense, is not necessarily required. This lessens the requirements for a sensor housing to surround the at least one sensor element.

The sensor element according to the present invention is able to be further refined by various advantageous embodiments. Thus, for example, when at least one diffusion channel in accordance with the above description is used, this at least one diffusion channel may exhibit a widening at least one outlet site leading to the gas chamber and/or to the reference chamber. This widening may be provided, for example, by a counterbore and/or a bore widening. In this way, in the exhaust tract, for example, it is possible to prevent the at least one diffusion channel from being clogged by liquid or solid impurities which would degrade the functionality of the sensor element.

In an embodiment, at least one cavity is provided that communicates with the at least one first electrode. This cavity is connected via the at least one diffusion channel to the at least one gas chamber and/or the at least one reference chamber. For example, this at least one cavity may include a widening of the at least one diffusion channel. Alternatively or additionally, the at least one cavity may also include a reaction chamber that directly adjoins the at least one first electrode and surrounds the entire at least one first electrode on one side, for example. This at least one cavity serves the purpose of allowing hydrogen, for example, or other reducing gases to react to completion (for example, by water formation) before arriving at the at least one first electrode and influencing the electrode potential there. In an embodiment, a catalyst may also be additionally provided in this at least one cavity, for example, in order to accelerate this process of reducing gases reacting to completion.

In an embodiment, the at least one flow-resistance element has at least one porous element. Thus, this at least one diffusion-resistance element corresponds to the “diffusion barrier” generally used in wide-range lambda sensors in front of the cathode, as described, for example, in Robert Bosch GmbH: “Sensoren im Kraftfahrzeug” [“Sensors in the Motor Vehicle], 2001, p. 116 ff. In an embodiment, this porous element of the at least one flow-resistance element is designed as a porous, extremely thick layer, as is known from the related art. In this context, a static pressure dependency k is advantageously used, which, for the use of gasoline-powered combustion engines, is at least 1 bar, but can be higher (for example, 3-4 bar). For Diesel-powered vehicles, k-values in the range of >0.1 bar, or, of >0.3 bar, for example, within the range of k=0.45±012 bar are used. In this context, static pressure dependency k denotes the pressure at which both diffusion types (Knudsen diffusion and gas-phase diffusion) are present in equal proportions. Thus, in embodiments at higher k values, the Knudsen diffusion dominates.

In an embodiment, the at least one diffusion-resistance element may also have a porous element in front of the at least one first electrode, for example, to prevent a contamination of the at least one first electrode. In this sense, the at least one diffusion channel described above is already a “porous” element having one single large pore. However, in an embodiment, in the region of the at least one first electrode, the at least one porous element is designed to be large-pored, i.e., to have a small k value, in order to provide a lowest possible flow resistance.

Embodiments of the present invention, namely the sensor element design, makes it possible to achieve an extremely low sensitivity of the lean pump current to rapid changes in total pressure (dynamic pressure dependency, DDA). The extremely small rich pump current exhibits a high dynamic pressure dependency. In an embodiment, as a function of the static pressure dependency of the lean pump current, which is greater than that of the rich pump current, even signal components of these two currents are able to be separated.

An embodiment of the sensor element provides that the diffusion of reducing gases, such as hydrogen, for example, toward at least one first electrode, is suppressed by a corresponding local adaptation of the temperature. Thus, in an embodiment, the at least one first electrode may be operated at a lower operating temperature than the at least one second electrode. For this purpose, at least one tempering element (for example, a heating resistor, a Pelletier element or a similar tempering element) may be provided, for example, which variably tempers the at least two electrodes, respectively, the corresponding resistor elements. By increasing the temperature, a flow through a resistor element may be prevented, whereas a diffusion is favored.

This may be accomplished, for example, by selecting a planar structure whereby the at least two electrodes reside in one plane and are variably tempered. For example, this variable tempering may be effected in that a heating element is used, the average distance between the at least one heating element and the at least one first electrode being greater, preferably by at least 10%, especially by at least 20%, than the average distance between the at least one heating element and the at least one second electrode. In this context, the average distance may be understood, for example, as the distance between the surface-area center points or an edge distance. As a result of this asymmetric tempering, the diffusion through the at least one flow-resistance element is favored in the region of the at least one second electrode, whereas the diffusion is suppressed in the region of the at least one first electrode operated at low temperature.

The sensor element in accordance with one of the above described embodiments, for example, may be produced in a layered structure. Thus, for example, the at least one first electrode and the at least one second electrode may be configured on opposite sides of the at least one solid electrolyte, the at least one first electrode being formed as the electrode facing the gas chamber (outer pump electrode, APE), and the at least one second electrode being formed as the electrode facing away from the at least gas chamber (inner pump electrode). To permit gas mixture from the at least one gas chamber to reach the at least one second electrode, a corresponding channel, a bore, a gas-inlet port or a similar orifice may be provided, as is the case, for example, when working with wide-range lambda sensors under the related art (see the quotation cited above).

Another embodiment provides that the at least one first electrode and the at least one second electrode are configured, in turn, on opposite sides of the at least one solid electrolyte, the at least one first electrode having an electrode (IPE) facing away from the gas chamber, and the at least one second electrode having an electrode (APE) facing the at least one gas chamber. Thus, this structure is the “inverse” of that previously mentioned.

Another embodiment provides for configuring the at least one first electrode and the at least one second electrode on the same sides of the at least one solid electrolyte, the at least one first electrode and the at least one second electrode each having at least one electrode facing the gas chamber.

### BRIEF DESCRIPTION OF THE DRAWINGS

Exemplary embodiments of the present invention are illustrated in the drawings and explained in greater detail in the following description.

FIG. 1A shows a sensor element corresponding to the related art.

FIG. 1B shows a pump current of the sensor element in accordance with FIG. 1A, plotted against schematically linearized lambda value λ;

FIG. 2A shows a sensor element according an embodiment of the present invention.

FIG. 2B shows a pump current as a function of the schematically linearized lambda value λ of the sensor element according to the exemplary embodiment of FIG. 2A.

FIG. 3 shows an embodiment of the sensor element having a cavity.

FIG. 4 shows an embodiment of the sensor element having a cavity and a connection to a reference channel.

FIG. 5A shows a sensor element having asymmetric electrode heating in a plan view.

FIG. 5B shows the sensor element according to the exemplary embodiment of FIG. 5A in cross section.

### DETAILED DESCRIPTION OF EMBODIMENTS

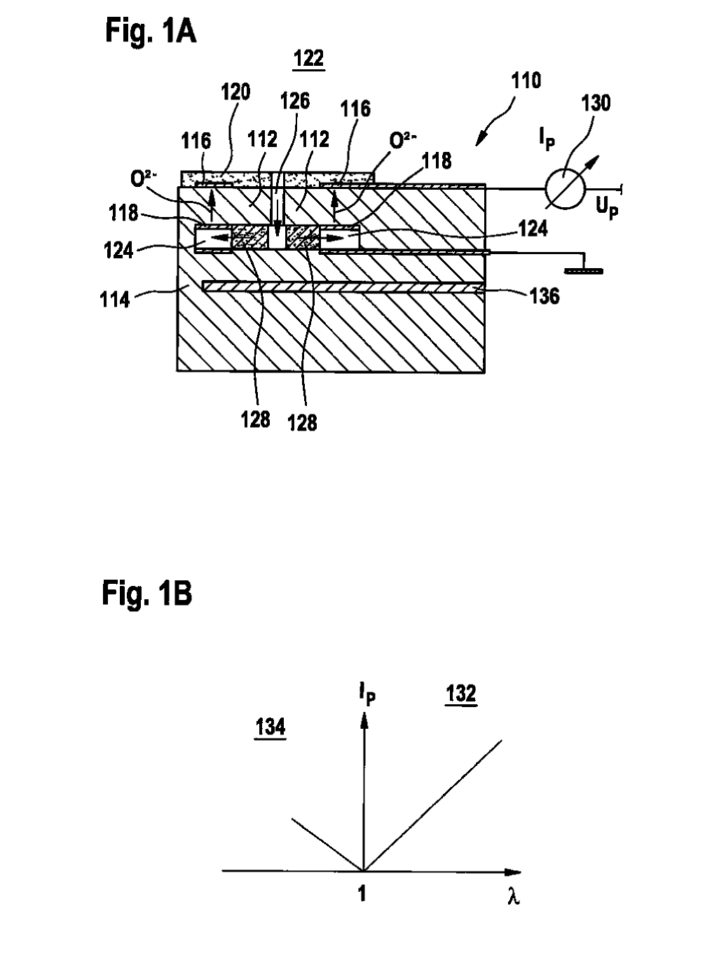

A structure of a sensor element 110 corresponding to the related art is shown in FIG. 1A. Here, as in the following design variations as well, this sensor element 110 is designed as a pump cell, as a wide-range lambda sensor. Sensor element 110 encompasses a solid electrolyte 112, which is customarily a zirconium oxide. However, depending on the type of gases to be detected, other ion-conducting solid electrolytes or mixtures thereof may be used. In this case, solid electrolyte 112 is the constituent component of a sensor body 114. Configured on opposite sides of solid electrolyte 112 are first electrodes 116 and second electrodes 118. In the present embodiment, first electrode 116 serves as outer pump electrode (APE), and second electrode 118 as inner pump electrode (IPE). First electrode 116 is separated by a porous protective layer 120 from surrounding gas chamber 122, porous protective layer 120 being configured in such a way that gases from first electrodes 116 are able to pass off through porous protective layer 120 without encountering any appreciable flow resistance. In an embodiment, the purpose of porous protective layer 120 is essentially to protect first electrode 116 from contamination.

In the exemplary embodiment in accordance with FIG. 1A, second electrode 118 is configured in an inner measurement chamber 124. To arrive at second electrode 118 from gas chamber 122, the gas mixture must pass through a gas-inlet port 126. From gas-inlet port 126, the gas mixture then arrives through diffusion and flow (in an embodiment, ideally only diffusion) through a porous element 128 (for example, often referred to as “diffusion barrier” under the related art, but actually used as a flow barrier) into measurement chamber 124.

In an embodiment, what is generally referred to as a “pump voltage” U is applied between the two electrodes 116 and 118 in the customary operation of sensor element 110 in accordance with FIG. 1A in such a way that second electrode 118 is operated as a cathode (negative electrode) and first electrode 116 as an anode. In the process, oxygen ions (O²⁻) form on second electrode 118, and, propelled by the electric field between the two electrodes 116, 118, migrate to first electrode 116. There, elementary oxygen forms again, which may escape as gas through porous protective layer 120. Sensor element 110 designed as a wide-range lambda sensor in accordance with FIG. 1A is operated within a pump voltage region of approximately 600 mV. This pump voltage suffices for operating the sensor element in the limit current operation; at the same time, however, the pump voltage being below the decomposition voltage of water, so that no decomposition of water should occur at second electrode 118.

In addition, sensor element 110 in accordance with FIG. 1A includes a heating element 136 which may be designed, for example, as a meander-shaped heating element (for example, as a platinum heating element). This heating element, which, in the case of a λ oxygen sensor, is typically heated at approximately 780° C., increases the ionic conductivity of solid electrolyte 112 and thereby provides for higher limit currents.

FIG. 1B shows pump current Iₚ, which, in the configuration in accordance with FIG. 1A, is measured by a current-measuring device 130. This pump current Iₚ is shown here schematically as a function of the lambda value λ, λ=1 corresponding to the stoichiometric gas mixture composition in gas chamber 122. Accordingly, the range for λ>1, which is symbolically denoted in FIG. 1B by reference numeral 132, is denoted as the “lean” range, whereas range λ<1 is denoted as the “rich” range and is symbolically denoted in FIG. 1B by reference numeral 134. As is evident from the curve of pump current Iₚ in FIG. 1B, sensor element 110 in accordance with the related art illustrated in FIG. 1A exhibits a considerable current in rich range 134. Due to this substantial increase (in terms of absolute value) in rich range 134, there are difficulties entailed in using solely the measurement of pump current Iₚ to make an assignment to a lambda value λ. This considerable pump current in rich range 134 is, as described above, caused, in particular, by reducing gases in the region of first electrode 116 operated as an anode.

Another effect, which is not illustrated in FIG. 1B, is the effect described above, where a deviation in the pump current from the proportionality to lambda value λ also occurs in lean range 132 in the vicinity of λ=1. This deviation is likewise caused by the presence of reducing gases, such as hydrogen, for example, in the region of first electrode 116. In the slightly lean range, in particular, pump currents higher than those which would correspond to proportionality, are frequently measured.

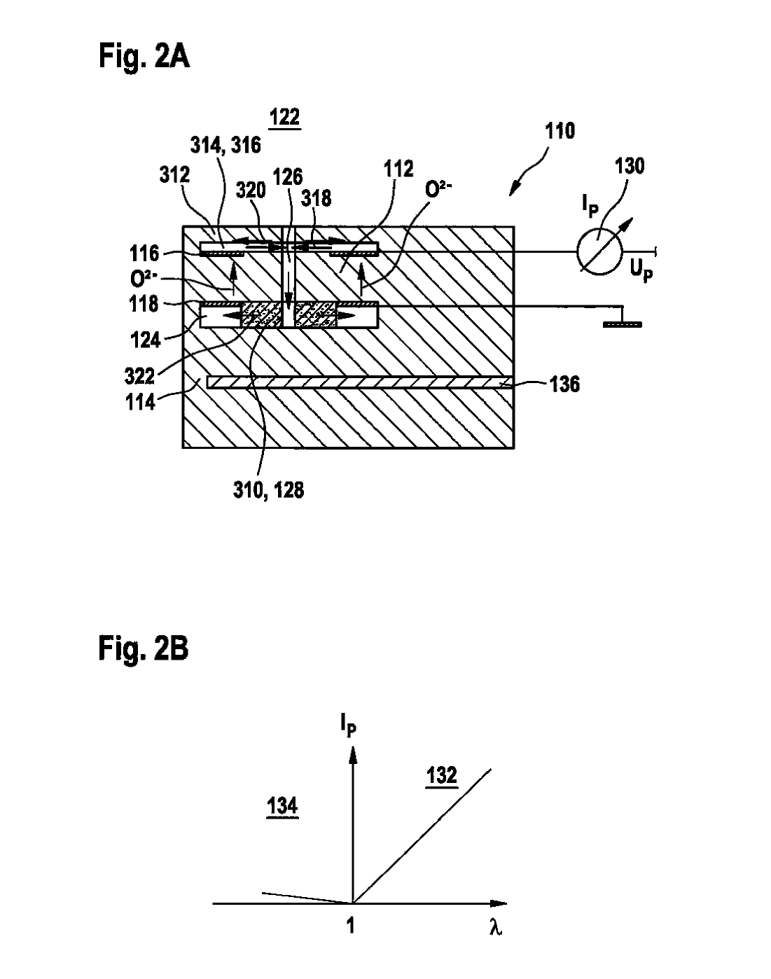

In contrast to the related art in accordance with FIG. 1A, a sensor element 110 according to the present invention is illustrated in FIG. 2A.

In principle, sensor element 110 in accordance with FIG. 2A shows substantial similarity to sensor element 110 in accordance with the related art in FIG. 1A. A solid electrolyte 112 is provided, in turn, which is contacted by two opposite electrodes 116, 118. Analogously to FIG. 1A, in turn, second electrode 118 is designed as an inner pump electrode and is configured in a measurement chamber 124. Gas mixture from surrounding gas chamber 122 may arrive via a gas-inlet port 126 into measurement chamber 124. Configured between gas-inlet port 126 and measurement chamber 124 is a flow-resistance element 310, which, in turn, analogously to FIG. 1A, is designed as a porous element 128 and through which gas mixture may diffuse (symbolically indicated in FIG. 2A by arrow 322). In this context, typical pore sizes are approximately 0.1 to 3.0 micrometers.

In this respect, sensor element 110 in accordance with the exemplary embodiment in FIG. 2A essentially corresponds to the related art in accordance with FIG. 1A. In contrast to sensor element 110 in accordance with FIG. 1A, sensor element 110 in the exemplary embodiment in accordance with FIG. 2A exhibits substantial differences in the region of first electrode 116, which, in turn, is conceived as an outer pump electrode. Thus, in the exemplary embodiment according to the present invention in accordance with FIG. 2A, no porous protective layer 120 is provided through which gas forming at first electrode 116 could pass directly into gas chamber 122. Instead, first electrode 116 is shielded by a cover element 312 from gas chamber 122. As a result, a diffusion-resistance element 314 in the form of a diffusion channel 316 forms between first electrode 116, respectively solid electrolyte 112 and cover element 312. This diffusion channel 316 leads away from first electrode 116 and ends in gas-inlet port 126. At an operating temperature of approximately 1000° C. and a pressure of 1 bar, the average free path length of the gas molecules is typically approximately 0.25 μm. Accordingly, in this embodiment, transversal dimensions (width, height) within the range of a few μm, and a length of a few mm are selected for diffusion channel 316. These dimensions have the effect of allowing oxygen that forms at first electrode 116 to pass off, under little flow resistance from first electrode 116, to gas-inlet port 126 (shown in FIG. 2A by thick arrow 318). On the other hand, due to the high diffusion resistance of long diffusion channel 316, hydrogen from gas chamber 122 is only able to arrive therefrom at first electrode 166 in a process that entails considerable difficulty and alter, respectively influence, the electrode potential there. This diffusion motion is symbolically illustrated in FIG. 2A by thin arrow 320.

Sensor element 110 in accordance with the exemplary embodiment according to the present invention in FIG. 2A is operated, in turn, by a pump voltage Uₚ of approximately 600 mV, and pump current Iₚ is measured. In addition, a heating element 136 is provided, with whose assistance sensor element 110 is operated at an operating temperature of typically some 100° C. up to approximately 1000° C.

In FIG. 2B, analogously to FIG. 1B, a pump current (limit current) through sensor element 110 is illustrated in accordance with FIG. 2A as a function of lambda value λ. It becomes apparent in this case that, due to the use of diffusion-resistance element 314 having a high diffusion resistance in front of first electrode 116 and of flow-resistance element 310 having a high flow resistance (but low diffusion resistance) in front of second electrode 118, the rich branch of pump current Iₚ has a substantially lower gradient (see area 134) than the pump current in lean range 132. This effect is mainly attributed to the shielding of first electrode 116 from hydrogen and/or other reducing gases. Also (not shown in FIG. 2B) in the slightly lean range (i.e., area 132 in the vicinity of λ=1), the falsification (for example, nonlinearities) is suppressed by the presence of hydrogen and/or other reducing gases, so that sensor element 110 in accordance with FIG. 2A down to the area near λ=1 may be used.

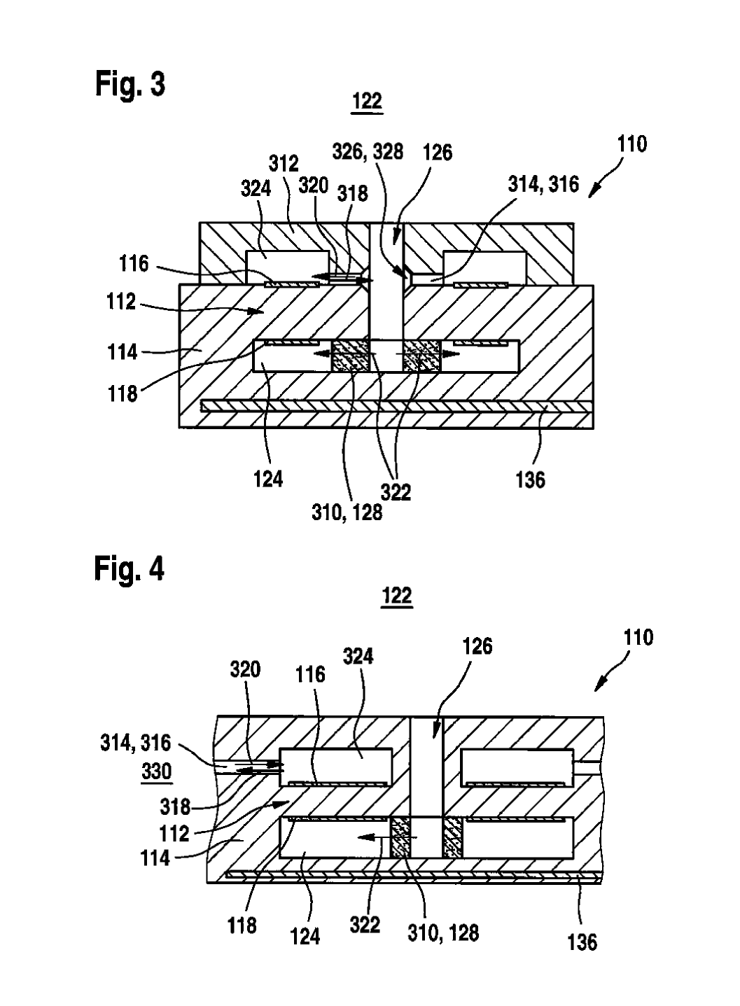

A second exemplary embodiment of a sensor element 110 in accordance with the present invention, which, in turn, may be used as a wide-range lambda sensor, is shown in FIG. 3. Sensor element 110 essentially corresponds in design to sensor element 110 in accordance with the exemplary embodiment in 2A, so that reference may be made to this figure for the function and composition of the individual elements. In contrast to the exemplary embodiment in accordance with FIG. 2A, sensor element 110 in accordance with the exemplary embodiment in FIG. 3 has two important modifications, however, which effect improvements in the functionality over the design in FIG. 2A and which may be realized individually or in combination. Thus, first of all, a cavity 324 that is rectangular in cross section is provided directly over first electrode 116. This cavity 324, for example, has a height and a width that are each substantially greater than the average free path length of the gas molecules. On the other hand, at an operating temperature of 1000° C., for example, and thus an average free path length of approximately 0.25 μm, the height of cavity 324 is, for example, some 10, or some 100 μm, up to in the region of approximately 1 mm. The width of cavity 324, i.e., its horizontal extent, is, for example, within the range of some 100 μm up to some mm. Cavity 324, for example, extends over the entire electrode surface of first electrode 116. Cavity 324 communicates via diffusion channel 316 with gas-inlet port 126. In an embodiment, diffusion channel 316 is provided, in turn, with a length of more than 0.5 mm. As described above, the purpose of cavity 324 is to render possible a reaction to completion of reducing gases (for example, hydrogen) before these gases are able to reach first electrode 116. In an embodiment, cavity 324 may also be “interposed” in diffusion channel 316, so that gas-inlet port 126 communicates through a first portion of diffusion channel 316 with cavity 324, which communicates, in turn, through a second section of diffusion channel 316 with first electrode 116. In this manner, the reaction to completion of the reducing gases in cavity 324 is spatially completely separate from first electrode 116.

As a modification, in the exemplary embodiment in accordance with FIG. 3, sensor element 110 has a widening 328 at an outlet site 326 of diffusion channel 316 leading into gas-inlet port 126. The purpose of this widening 328 is to prevent a contamination of diffusion channel 316 and a clogging by solid or liquid impurities in the gas mixture. In the exemplary embodiment in accordance with FIG. 3, widening 328 is in the form of a counterbore. Stepped widenings or other forms of widenings are also conceivable.

On the other hand, for the operation of sensor element 110 in accordance with the exemplary embodiment in FIG. 3, a pump voltage is applied between electrodes 116, 118; analogously to FIG. 2A, first electrode 116 preferably being operated, in turn, as an anode, and second electrode 118 as a cathode.

A third exemplary embodiment of a sensor element 110 according to the present invention is illustrated in FIG. 4. Sensor element 110 in accordance with the exemplary embodiment illustrated in FIG. 4 has similarities to the exemplary embodiment in accordance with FIG. 3. Accordingly, with respect to the function and designation of the individual elements, reference may be made, for the most part, to this exemplary embodiment. Via first electrode 116 (typically anode), in turn, a cavity 324 is provided, which, in terms of dimensioning, may be configured analogously to cavity 324 in FIG. 3. In addition, a diffusion channel 316 is provided, in turn, via which oxygen may pass off from first electrode 116 (reference numeral 318), which, however, largely prevents a hydrogen diffusion (reference numeral 320) toward first electrode 116.

In contrast to the exemplary embodiment in FIG. 3, however, diffusion channel 316 does not lead into gas-inlet port 126 (and thus directly into gas chamber 122), but rather into a reference chamber 330. This reference chamber 330, which may, for example, be an underhood environment of a combustion engine, is separate from gas chamber 122, so that gas mixture is not able to arrive in reference chamber 330. This ensures that hydrogen and/or other reducing gases are not able to reach first electrode 116 since only vanishingly small quantities of such reducing gases are typically present in the reference chamber (for example, ambient air). Accordingly, the need for diffusion channel 316 could even be completely eliminated. Thus, in its design, sensor element 110 in accordance with the exemplary embodiment in FIG. 4 resembles known step-change sensors, where an electrode is typically acted upon by a reference gas. However, in contrast to step-change sensors of this kind, in the exemplary embodiment in accordance with FIG. 4, sensor element 110 is operated as a wide-range lambda sensor since a (typically constant) pump voltage (the contacts are not shown in FIG. 4) is applied between the two electrodes 116, 118, and the pump current is measured.

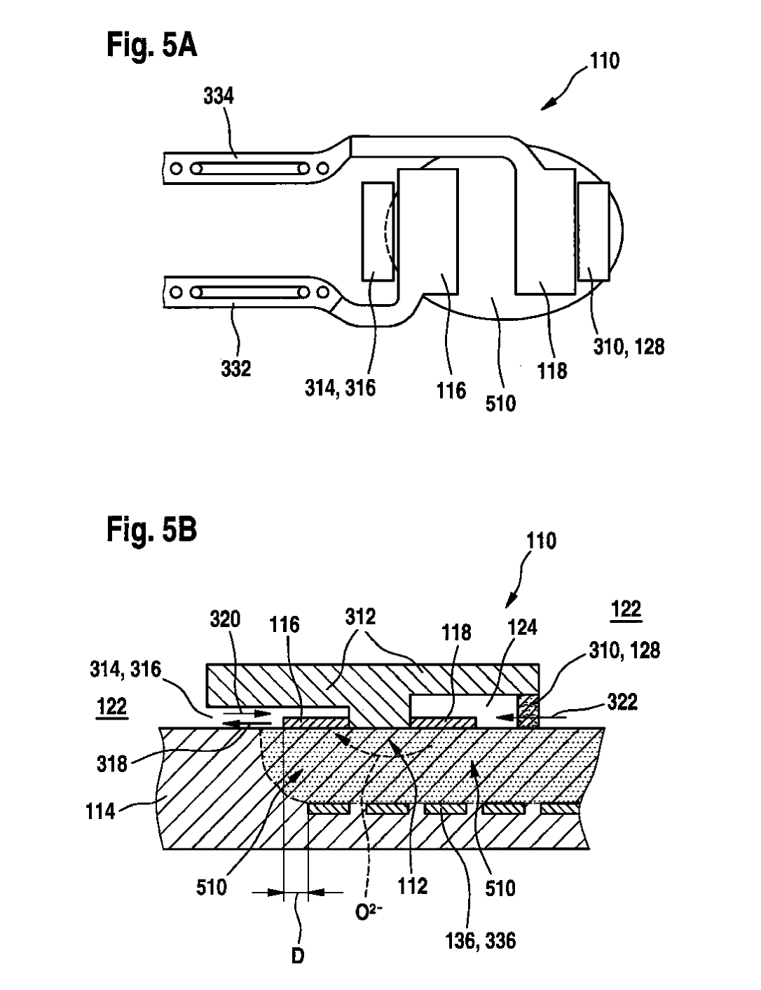

An exemplary embodiment of a sensor element 110 is schematically shown in FIGS. 5A and 5B in a plan view (FIG. 5A) and in a sectional representation in a lateral view (FIG. 5B). In this exemplary embodiment, a heating element 136 is used for an asymmetrical heating of both electrodes 116, 118 in such a way that first electrode 116 is operated at a lower operating temperature than second electrode 118. This may be accomplished, in particular, by the asymmetrical configuration of heating element 136 in such a way that a heating zone which is symbolically denoted in FIG. 5A and in FIG. 5B by reference numeral 510 extends to a greater degree to second electrode 118 than to first electrode 116.

Sensor element 110 in accordance with the exemplary embodiment in FIGS. 5A and 5B is an example of a design where both electrodes 116, 118 are configured on the same side of a solid electrolyte 112. Accordingly, the oxygen ionic current in the vicinity of the surface is effected through solid electrolyte 112 approximately in the horizontal direction. Thus, in contrast to the “stacked” or vertical designs in accordance with FIG. 2A, 3 and 4, it is a question in FIGS. 5A and 5B of a planar design.

A cover element 312 is provided, in turn, which, in this exemplary embodiment, covers both first electrode 116 as well as second electrode 118. Analogously to the exemplary embodiment in FIG. 2A, for example, in the region of first electrode 116, a diffusion-resistance element 314 having a diffusion channel 316 is provided. For the dimensioning, reference may be made for the most part to FIG. 2A. First electrode 116 is in fluid communication with gas chamber 122 via diffusion channel 316, thereby allowing oxygen to pass off (reference numeral 318), whereas a diffusion of hydrogen toward first electrode 116 (reference numeral 320) is impeded by diffusion channel 316. Diffusion channel 316, in turn, preferably has a length (i.e., from the edge to gas chamber 122 up to the most proximate edge of first electrode 116) of preferably more than 0.5 mm and of preferably less than 20 mm, in order to ensure, on the one hand, a high diffusion resistance and, on the other hand, a low diffusion resistance.

In addition, above second electrode 118, cover element 312 forms a measurement chamber 124, which, in turn, typically has a height of at least some 10, preferably of some 100 μm, and up to some mm. Analogously to the exemplary embodiment in FIG. 2A, this measurement chamber 124 is sealed off toward gas chamber 122 by flow-resistance element 310 in the form of a porous element 128.

The planar specific embodiment in accordance with FIGS. 5A and 5B renders possible an especially simple electrical contacting of electrodes 116, 118 via electrode contacts 332, 334 on the surface of solid electrolyte 112 without the need for vias. First electrode 116 is typically operated, in turn, via electrode contact 332 as an anode, whereas second electrode 118 is operated via electrode contact 334 as a cathode. The electrical circuit is implemented and constant pump voltage Uₚ is applied analogously to the exemplary embodiment in FIG. 2A.

In accordance with the exemplary embodiment in FIGS. 5A and 5B, sensor element 110 is typically operated, in turn, at some 100° C. to approximately 1000° C. This enhances the ionic conductivity of solid electrolyte 112, as described above. Heating element 136 (in the case of which, it may generally also be a question of a tempering element 336, thus, for example, also of a cooling element) is configured asymmetrically relative to electrodes 116, 118. This asymmetry may be effected, for example, in that the outer edge of first electrode in the plan view (FIG. 5A) projects by a distance D (see FIG. 5B) beyond heating element 136, which, for example, may amount to some mm, whereas second electrode 118 is completely horizontally covered by heating element 136. In this manner, for example, in the area of diffusion channel 316 (or also additionally in the area of first electrode 116), an operating temperature is set which is lower, for example, by approximately 20% (on the Kelvin temperature scale) than the operating temperature in the area of second electrode 118, of measurement chamber 124 and/or of flow-resistance element 310. In this manner, since the diffusion of hydrogen (reference numeral 320) through diffusion channel 316 increases with rising temperature, this diffusion may be additionally suppressed, whereas a diffusion through porous element 128 of flow-resistance element 310 is benefited by the elevated temperature.

As a variant of the specific embodiment in FIG. 5B, diffusion-resistance element 316 can also have one or a plurality of channels (drilled substantially perpendicularly, for example, by a laser) in cover element 312 that connect gas chamber 122 with the chamber via first electrode 116. An embodiment includes a diffusion channel 316 in thin-film technology, for example, as a lamina-shaped diffusion channel having a plurality of adjacent channel planes, or an embodiment that makes use of a plurality of adjacent, small, parallel diffusion tubes. These types of small, parallel diffusion tubes may be realized, for example, by manufacturing methods for which a laser drilling method is used.

1-17. (canceled)

18. A sensor element for determining at least one physical property of a gas mixture in at least one gas chamber, in particular, for determining an oxygen concentration in the exhaust gas of an internal combustion engine, comprising:
at least one first electrode and at least one second electrode;
at least one solid electrolyte that connects the at least one first electrode and the at least one second electrode, the at least one first electrode being connected via at least one diffusion-resistance element to at least one of the at least one gas chamber and at least one reference chamber, the at least one second electrode is connected via at least one flow-resistance element to the at least one gas chamber,
wherein the at least one flow-resistance element and the at least one diffusion-resistance element are designed in such a way that the limit current of the at least one first electrode is smaller in magnitude than the limit current of the at least one second electrode.

19. The sensor element as recited in claim 18, wherein the at least one flow-resistance element and the at least one diffusion-resistance element are provided such that the at least one flow-resistance element has a greater flow resistance than the at least one diffusion-resistance element.

20. The sensor element as recited in claim 18, wherein the at least one diffusion-resistance element has a greater diffusion resistance than the at least one flow-resistance element.

21. The sensor element as recited in claim 18, wherein the limit current of the at least one first electrode is smaller in magnitude than 1/100 of the limit current of the at least one second electrode.

22. The sensor element as recited in claim 18, wherein the limit current of the at least one first electrode is 1 to 20 microamperes and the limit current of the at least one second electrode is 500 microamperes to 3 milliamperes.

23. The sensor element as recited in claim 18, wherein the at least one diffusion-resistance element has a diffusion channel via which the at least one first electrode is connected to the at least one gas chamber and the reference chamber.

24. The sensor element as recited in claim 23, the at least one diffusion channel having a channel having a height within a range of 2 L to 25 L, a width within the range of 2 L to 25 L, and a length within the range of 0.5 mm and 20 mm, L being the average free path length of the molecules of the gas mixture at an operating pressure and an operating temperature of the sensor element.

25. The sensor element as recited in claim 23, wherein the at least one diffusion channel exhibits a widening at least one outlet site leading to the at least one of a gas chamber and the reference chamber.

26. The sensor element as recited in claim 23, further comprising at least one additional cavity that communicates with the at least one first electrode, the at least one cavity being connected via at least one diffusion channel to at least one of the at least one gas chamber and the at least one reference chamber.

27. The sensor element as recited in claim 26, wherein the at least one cavity has at least one of a catalyst, a nickel catalyst, and a platinum catalyst.

28. The sensor element as recited in claim 18, the at least one diffusion-resistance element having at least one porous element.

29. The sensor element as recited in claim 18, wherein the at least one flow-resistance element has at least one porous element.

30. The sensor element as recited in claim 29, wherein the at least one porous element has a static pressure dependency k of between 0.3 bar and 1.3 bar.

31. The sensor element as recited in claim 18, wherein the at least one diffusion-resistance element has a reference channel, the at least one reference channel connecting the at least one first electrode to the at least one reference chamber that is separated from the at least one gas chamber.

32. The sensor element as recited in claim 18, wherein at least one tempering element is provided, the at least one tempering element being designed for operating the at least one first electrode at a lower operating temperature than the at least one second electrode.

33. The sensor element as recited in claim 18, further comprising at least one of the following layered structures:
a) the at least one first electrode and the at least one second electrode are configured on opposite sides of the at least one solid electrolyte, the at least one first electrode having an electrode facing the gas chamber, and the at least one second electrode having an electrode facing away from at least one gas chamber;
b) the at least one first electrode and the at least one second electrode are configured on opposite sides of the at least one solid electrolyte, the at least one first electrode having an electrode facing away from the gas chamber, and the at least one second electrode having an electrode facing the at least one gas chamber;
c) the at least one first electrode and the at least one second electrode are configured on the same sides of the at least one solid electrolyte, the at least one first electrode and the at least one second electrode each having at least one electrode facing the gas chamber.

34. A method for determining at least one physical property of a gas mixture, comprising:
using a sensor element in accordance with the following:
at least one first electrode and at least one second electrode;
at least one solid electrolyte that connects the at least one first electrode and the at least one second electrode, the at least one first electrode being connected via at least one diffusion-resistance element to at least one of the at least one gas chamber and at least one reference chamber, the at least one second electrode is connected via at least one flow-resistance element to the at least one gas chamber, wherein the at least one flow-resistance element and the at least one diffusion-resistance element are designed in such a way that the limit current of the at least one first electrode is smaller in magnitude than the limit current of the at least one second electrode;
operating the at least one first electrode as an anode;
operating the at least one second electrode is as a cathode;
applying a pump voltage of between 100 mV and 1.0 V between the at least one first electrode and the at least one second electrode; and
measuring a pump current through the sensor element.

35. The sensor element as recited in claim 18, wherein the sensor element designed for determining an oxygen concentration in the exhaust gas of an internal combustion engine.

36. The sensor element as recited in claim 18, wherein the limit current of the at least one first electrode is smaller than 1/1000 of the limit current of the at least one second electrode.

37. The sensor element as recited in claim 18, wherein the limit current of the at least one first electrode is 10 microamperes, and the limit current of the at least one second electrode is 1.5 milliamperes.

38. The method of claim 34, wherein the pump voltage is between one of 300 mV and 800 mV, and 600 mV and 700 mV, and is applied between the at least one first electrode and the at least one second electrode, a pump current through the sensor element being measured.
